(19) United States
(12) Patent Application Publication
(10) Pub. No.: US 2004/0266430 A1
(43) Pub. Date: Dec. 30, 2004

(54) Method and device of ordering channels to be scanned in wireless network association

(76) Inventors: Max Fudim, Kiryat Bialik (IL); Oren Kaidar, Givat Ada (IL); Igor Markov, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/608,038

(22) Filed: Jun. 30, 2003

(51) Int. Cl. H04Q 7/20

(52) U.S. Cl. 455/434; 455/515

(57) ABSTRACT

There are presented a method and device for ordering the channels to be scanned by a station that is looking to associate with a network by way of an access point. The order in which channels will be scanned is based on criteria relating to prior associations by the station over specific channels or access points. Such criteria may be collected and stored in an associative history of a station, which may include, for example, the time of past associations on a channel, the performance of an access point in prior associations, or other criteria determined by a station user.

### BACKGROUND OF THE INVENTION

In a wireless local area network (WLAN) or other wireless network, a station searching for a basic service set (BSS) such as for example a peer or an access point, may scan a set of channels looking for an association. The order in which channels are scanned by a station may be determined by a station arbitrarily. Alternatively, scanning may begin at, for example, channel 1 and may proceed sequentially or in some other order until each channel available to the station has been scanned. Scanning each channel available to the station takes time, and a station may have to remain on each channel for a designated period of time before proceeding to the next channel. Scanning each of the channels available to the station before selecting a desired or optimal channel on which to associate may cause delays in establishing association of the station with an access point or wireless peer.

### BRIEF DESCRIPTION OF THE DRAWINGS

Embodiments of the invention will be understood and appreciated more fully from the following detailed description taken in conjunction with the drawings in which:

FIG. 1 is a schematic diagram of components of a station and of a network in accordance with an embodiment of the invention;

FIG. 2 is a flow diagram depicting a series of operations for scanning channels in accordance with an embodiment of the present invention;

FIG. 3 is a diagram depicting criteria that may be included in an associative history of a station and used to order channels to be scanned in accordance with an embodiment of the invention;

FIG. 4 is a diagram of a process of updating an associative history of a station in accordance with an embodiment of the invention; and

FIG. 5 is a histogram showing successful associations with a peer by a station during various hours of the day, in accordance with an embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification, discussions utilizing terms such as “processing,” “computing,” “calculating,” “determining,” or the like, refer to the action and/or processes of a processor, computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer, communication device or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein.

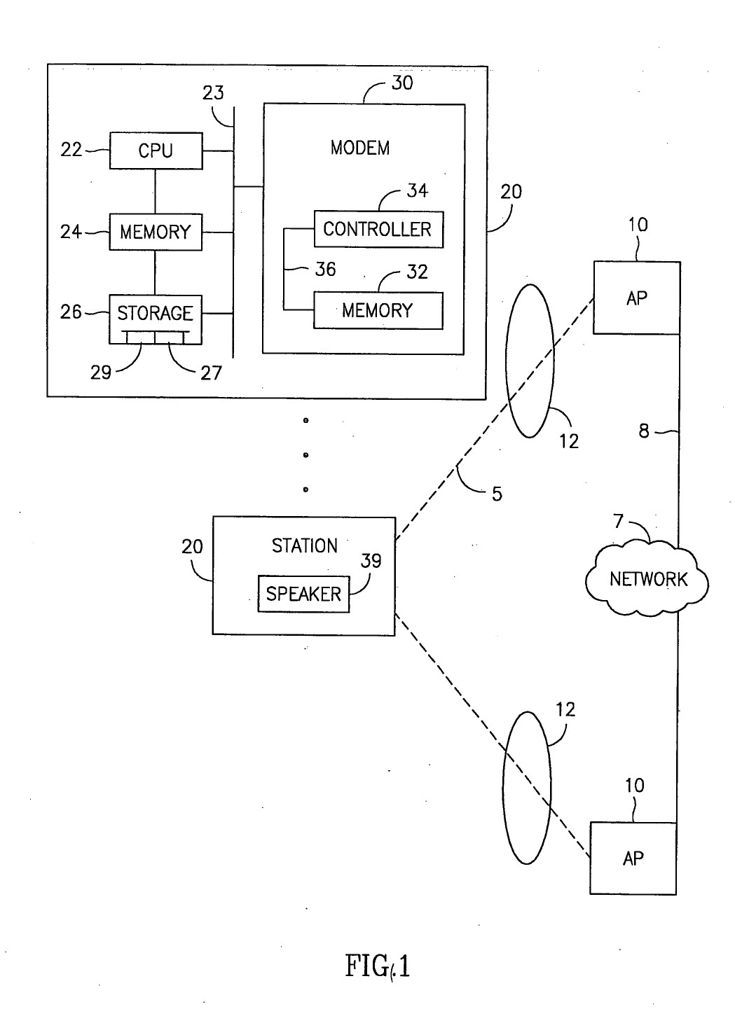

FIG. 1 is a schematic diagram of components of a station and of a network in accordance with an exemplary embodiment of the invention. Referring to FIG. 1, network 7 may for example include one or more peers, such as for example other wireless receiving and broadcasting device, or access points (AP) 10, which may associate stations 20 with a network 7. Network 7 may for example be a wireless network or a network that includes wireless components. For example, in some embodiments, network 7 may be a local area network (LAN) with wireless links, such as a WLAN. In other embodiments, network 7 may be for example a wide area network (WAN). Peers or APs 10 may in some embodiments associate stations 20 with other equipment such as for example personal computers, workstations, printers, etc. Peers, such as for example APs 10, may be linked to network 7 by wireless communication or by wires 8. Network traffic 5 between stations 20 and a peer or AP 10 may for example be radio waves carrying digital data, but in other embodiments, traffic 5 may be in different forms such as infrared or other electromagnetic waves.

In an exemplary embodiment of the invention, station 20 which may be seeking to associate with network 7, may scan channels 12 looking for a suitable peer or AP 10 to facilitate the association. The order or sequence of the channels 12 that may be scanned by station 20 may, in an exemplary embodiment, be determined by a processor 22 based on an associative history 29 of a station 20, such as for example data collected from prior associations of a station 20.

A peer or AP 10 may be for example a wireless bidirectional communications link or wireless interface means through which wireless devices such as, for example station 20, may associate with a network such as network 7. In embodiments of the invention, other communications links, having structures and functionalities other than those of an access point 10 may be used.

Station 20 may be or include a wireless communication device. For example, station 20 may for example be a personal computer which may for example be portable (e.g., a “laptop”) and which may include a wireless modem 30. Such a wireless modem 30 may be, for example, a mini-PCI wireless network adaptor or may be another type of wireless communications device. Stations may be other computing devices, such as personal digital assistants, cellular telephones, etc.

Station 20 may include, for example, a controller or processor 22 (e.g., one or more central processing units (CPUs) or microprocessors), a memory or storage unit 24 (e.g., one or more random access memories (RAMs) or read only memories (ROMs)), mass storage unit 26 (e.g., a hard disk or other non-volatile memory), one or more busses 23, and a wireless modem 30. Wireless modem 30 may include standard computational components, such as, for example, a controller 34, such as a microprocessor, CPU, etc, a memory unit 32, and one or more busses 36. Station 20 may in some embodiments include other components such as for example a dipole antenna.

Network 7 may in certain embodiments be a WAN such as for example the Internet, a WLAN such as, for example, those that may connect a LAN to wireless stations, or smaller networks such as those used by components based on for example, the Bluetooth standard, such as scatternets, micronets or piconets, etc.

In some embodiments, either or both of processor 22 or controller 34 may act as a controller to carry out a method according to an embodiment of the present invention. While in FIG. 1 such components are shown in only one station 20, other stations 20 may include similar components. Some stations 20 may include different sets of components and different functionalities, and may carry out the methods discussed herein in different manners. In other embodiments, having equipment with different configurations, different components may act as a controller 34.

In some embodiments, a peer or AP 10 may communicate or associate with station 20, with network 7, with other wireless components, or with other APs 10. For example, AP 10 may communicate with station 20 using packets or other discreet units of information, to provide stations 20 with access to network 7. In some embodiments, AP 10 may operate on a single frequency or channel 12 (represented in FIG. 1 by a set of traffic 5) and may provide a Basic Service Set (BSS) to clients such as stations 20 on such channel 12. In some embodiments, in a given local area, a single AP 10 may operate, although multiple APs 10 may operate in the similar area and on the same channel if, for example, demand warrants. Other systems for providing access to network 7 are possible.

In an exemplary embodiment, a station 20 may enter a local service area, and may attempt to associate with an AP 10 or other peer in such area. Such an attempt may be initiated, for example, at the beginning of a network session in order to associate or establish access between a station 20 and a network 7, or, during a network session for reasons such as for example finding a better path for access to the network 7, accessing another network 7 component, or as a result of movement of station 20 out of range of one AP 10 and into the range of another AP 10. Other factors may trigger a scan of channels by a station. In some embodiments a station 20 may scan channels 12 on a regular basis during an associative session.

In attempting to associate, a station 20, possibly by way of its modem 30, may scan some or all of the channels 12 upon which it may be able broadcast and receive signals. In some embodiments, scanning may entail tuning a receiver or other signal receiving device of station 20 or modem 30 to a channel 12 and listening for informational packets, beacons or other signals that may be broadcast on such channel 12 by a peer or AP 10. This process may be repeated for some or all of the channels 12 on which station 20 may receive or transmit signals as station 20 searches for peers or APs 10 with which to establish an association. In other embodiments, station 20 may broadcast a signal such as a probe request to a peer such as an AP 10 in the local area as a request to establish an association or find a BSS or AP 10. A peer or AP 10 may send an association response to station 20 inviting station 20 to use the services of AP 10 for achieving access. This process may be repeated for some or all of channels 12 on which station 20 may receive or transmit signals.

Scanning a channel may take from approximately 10 to approximately 120 miliseconds per channel. A station may in some embodiments scan from several channels to 40 channels as part of an attempt to establish association. Other numbers of channels 12 may be scanned. Certain countries or geographical regions around the world may designate or reserve frequencies, channels 12 or groups of channels 12 for communication by wireless devices such as wireless modems 30 or stations 20. Some stations 20 may scan channels 12 by group, where such group may for example correspond to the group of channels 12 available in a given region.

In selecting a channel 12 upon which to associate, a station 20 may in some embodiments evaluate measures or criteria attributable to such channel 12 or AP 10, such as for example, distance of such AP 10 from a station 20 or noise on a channel 12. Other criteria may include for example, traffic levels detected on such channel 12, quality of service that may be available from such AP 10 such as for example, average number of retries, transmission rates or receiving rates, security levels or other characteristics of such channel 12 or of an AP 10 using such channel 12. Some stations 20 may be enabled with a function that lets a user of such station 20 or another operator create a user profile 27 that designates and/or orders channels 12 that the station 20 is directed to scan in attempting to associate. Factors such as a user's special security requirements, quality of service needs or other associative characteristics desired by a user may influence a selection of a user's profile 27 or an order of channels 12 to be scanned by a station 20.

In an associative session between a station 20 and a network 7 over a specific channel 12 or with an AP 10, a station 20 may in some embodiments, collect and record data on the identity of the AP 10 with which it associated, as well as other data concerning the AP 10 or the associative session, such as for example, the quality, efficiency, security, average number of retries, transmission rate, receiving rate or other characteristics of the associative session. Such collected data and other data may constitute an associative history 29 of a station 20 on one or more channels 12 or with one or more APs 10. An associative history 29 may in some embodiments also include for example, the time of day that a station 20 succeeded in associating on a channel 12 or with an AP 10, and the characteristics of the association at such time of day. Associative histories 29 may be stored in, for example, mass storage unit 26, in modem's 30 memory unit 32 or in another non-volatile memory or data storage area in, accessible by, or connected to station 20. In some embodiments, an associative history 29 may include other information about particular channels 12 or APs 10. In other embodiments, associative history 29 may be stored as or include a multi-dimensional array that records data about a channel 12 or AP 10 such as its performance at various times of day or for various tasks (such as for example Internet surfing, data transferring, music downloading etc.). In embodiments of the invention, an associative history 29 may include information stored about many channels 12 or many APs 10. For example, an associative history 29 may record data about associations or associative sessions by a station 20 on a particular channel 12 or with a particular AP 10 on particular days of a week, such as workdays or weekends. Other kinds of data that may, by way of example, be collected in an associative history 29 and used as criteria for ordering channels 12 to be scanned are the location of a station 20 at particular times (such as for example, at home, at work etc., as may be indicated by a global positioning system GPS device or other location indicator that may be included in a station 20), and/or the proximity of a station 20 at particular times to an AP 10 and the effect of such proximity on communication quality, etc. For example, some peers or AP's 10 may exhibit better performance over long distances, and a station 20 may in some embodiments measure the distance between itself and an AP 10. Other characteristics or criteria or sets of characteristics or data may in some embodiments be included in an associative history 29, and may be taken into account in ordering channels 12 to be scanned.

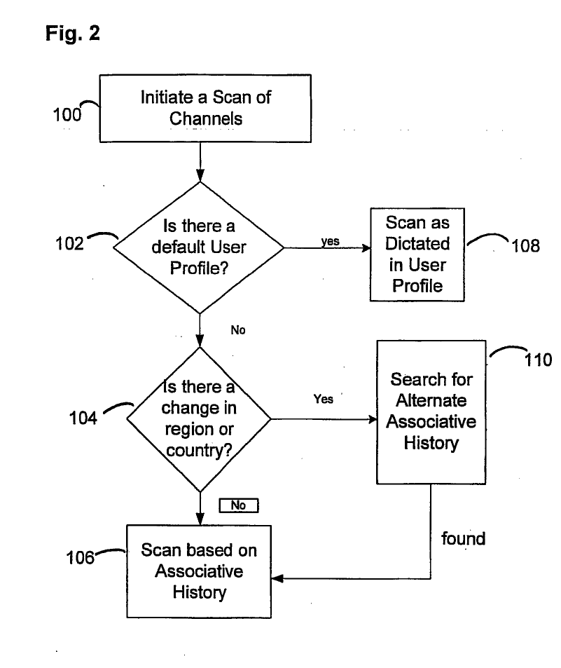

Reference is made to FIG. 2, a flow diagram depicting a series of operations for scanning channels 12 in accordance with an embodiment of the invention. In an embodiment of the invention depicted in block 100, station 20 may initiate a scan of channels 12 as part of its attempt to find a BSS, or to change the path of its association with a network 7. In block 102, station 20 may determine whether there is a default user profile 27 that dictates the order of channels 12 to be scanned. If a user profile 27 is found (block 108), station 20 may scan channels 12 in an order dictated by such user profile 27. In some embodiments, a station 20 may first scan using a default user profile 27, and then scan based on an order determined by an associative history 29. In other embodiments, a user profile 27 may for example dictate or direct that specific channels 12 are to be included in an order that may otherwise be determined based on an associative history 29. Other combinations of using both a user profile 27 and an associative history 29 are possible. In block 104, station 20 may determine whether its location has changed to regions or countries wherein the channels 12 available to it are other than those about which it has an associative history 29. If its location has so changed, station 20 may search mass storage unit 26, memory 24 or other components for other associative histories 29 that may match the channels 12 available in its current region or country (block 110). If an alternative associative history 29 is found, station 20 may scan channels 12 in an order based on such alternative associative history 29. Alternatively, in block 106, station 20 may initiate a scan of channels 12 in an order determined by an associative history 29.

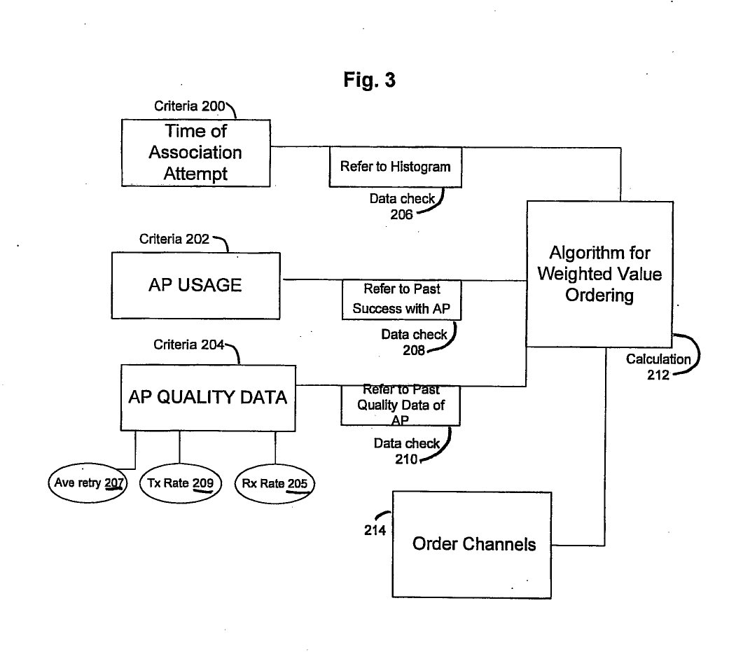

Reference is now made to FIG. 3, a diagram depicting some examples of the criteria that may be included in an associative history 29 of a station 20, and used to order channels 12 to be scanned in accordance with an embodiment of the invention. Criteria 200, such as the time of day and/or day of week of the attempted association may, in some embodiments be a determinant criteria that may be considered in ordering channels 12 to be scanned. For example, associative history 29 may indicate that for example, on 9 AM on weekday mornings, station 20 frequently successfully associates with a particular AP 10 or on a particular channel 12, for example an AP 10 on a channel 12 corresponding to, for example 2412 Mhz, as such may be in use at for example, a user's work place. To make such determination, station 20 may in data check 206, refer to a histogram that may be included in associative history 29, wherein are stored records correlating an AP 10 that broadcasts on a channel 12 with the times of day and/or days or week during which station 20 associated with such AP 10 on a channel 12. In some embodiments, a histogram, or an electronic data version thereof, may be created and stored for some or all of the peers or APs 10 which a station 20 may have identified or for example for those peers or APs 10 with which it may have associated in the past. In some embodiments, a histogram or electronic record may be stored by a station 20 for some or all APs from which said station 20 may have received a packet or other identifying data.

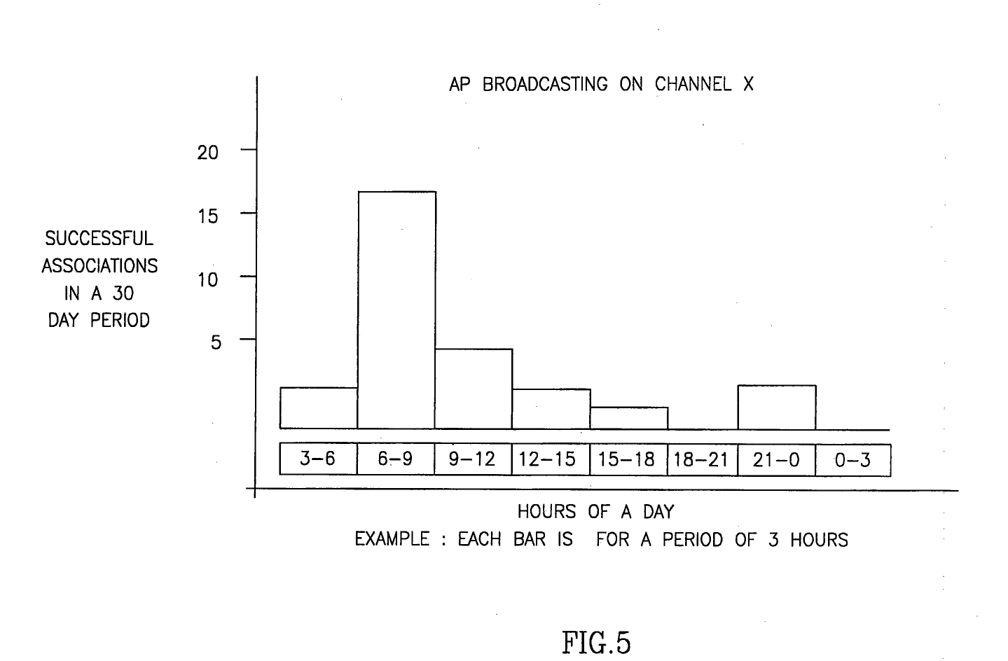

For example, and referring to FIG. 5, station 20 may create or store a histogram (or another suitable electronic data record) corresponding to one or more APs 10 broadcasting on a channel 12. In some embodiments, an X axis, for example, of such histogram may list hours of a day and/or days of a week, and a Y axes, for example, may indicate a number of successful associations with such AP 10 on a channel 12. Other axis and other criteria are possible.

In the present example, a histogram may indicate that over the past 30 days, or some other period, station 20 made 16 successful associations with a particular AP 12 on a channel 12, during the hours of 6 AM and 9 AM. A similar histogram or its equivalent may be stored for other APs 10. In determining the order of channels 12 to be scanned, station 20 may consult some or all of its histograms and order the channels 12 to be scanned according to the channels 12 upon which are broadcasting various APs 10 for whom it has an associative history 29. Such an ordering may be for example, in descending order according to the number of successful associations on with APs on such channels 12 over the past 30 days at the hour during which the current association is being attempted. Returning to the example and FIG. 3, and in an embodiment of the invention, in an attempt to associate on a weekday at 9 AM, station 20 may order the channels 12 to be scanned such that a particular channel 12 on which a particular AP 10 about which such station has stored a histogram, may be scanned first or otherwise advanced or given preference in the order of channels 12 to be scanned by such station 20 in its attempts to associate at such hour or time of day. In other embodiments, the order of channels 12 to be scanned may be arranged in, for example descending order on the basis of the number successful associations with such AP 10 on such channel 12 during for example the prior 30 days.

Similarly, station 20 may on the basis of data check 208 determine that, for example, station 20 has frequently associated with a specific AP 10 or on a particular channel 12 (criteria 202). On the basis of such frequent usage, or the association success rate of station 20 with a particular AP 10, relative to lower association success rates with other APs 10 on other channels 12, such channel 12 may, in an embodiment of the invention be advanced in the order of channels 12 to be scanned when station 20 makes association attempts.

In some embodiments, station 20 may in data check 210 evaluate the data quality of an AP 10 (criteria 204), such as for example, data on average number of retries 207, transmission rates 209 and receiving rates 205 for an AP 10 as were collected in prior associations with such AP 10. In such case, a histogram (or its electronic equivalent) may be created and stored to show the number of times over a given period, such as for example, the past 30 days, a given channel 12 provided either satisfactory or unsatisfactory transmission quality to station 20. The channels 12 to be scanned may be arranged, for example so that the channels 12 with the highest quality as recorded in the associative history 29 are scanned, for example first, and the channels 12 with lower quality are scanned later. Various other measures or criteria may be used to arrange the order of channels 12 to be scanned and data analysis means other than histograms can be implemented.

In some embodiments the order of channels 12 to be scanned as may be arranged on the basis of one criteria may differ from the order of channels 12 to be scanned that may be arranged on the basis of another criteria. For example, a particular channel 12 may be ordered to be scanned first on the basis of a criteria such as time of association, but such channel 12 may be ordered for example last on the basis of AP 10 transmission quality. In such a case, and in some embodiments, a weighted value algorithm can be used to give varying importance to the orders determined on the basis of the various criteria. For example, a user may want to give for example, twice as much importance to a criteria such as AP quality criteria than to a criteria such as past successful associations. The final order for channels to be scanned as determined in accordance with embodiments of the invention may in some embodiments be the weighted average place of a channel in the various orders that are arranged. Other weighting measures to provide a measure of relative importance of one criteria over another may be applied and other algorithms may be used. An algorithm may, in certain embodiments be pre-set, in a modem 30 or station 20 or in other components connected therewith, or may be adjustable by a user or other operator of a station 20. On such basis, station 20 may in embodiments of the invention, scan channels 12 in the order dictated by the algorithm (block 214).

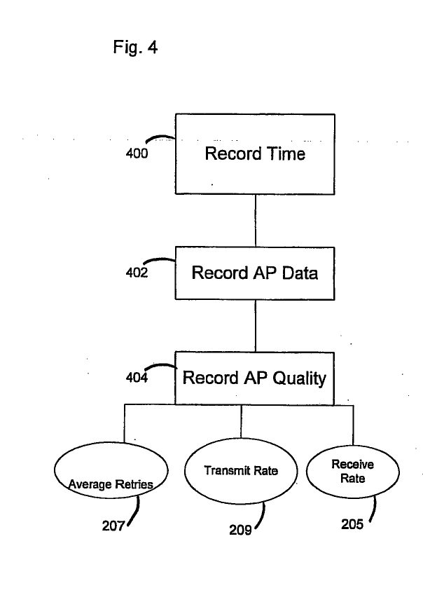

Reference is made to FIG. 4, a diagram of an operation creating or updating an associative history 29 of a station 20 in accordance with an embodiment of the invention. In certain embodiments, station 20 may record for example the time of each of its associative sessions (block 400) and the identity of the AP 10 (block 402) and channel 12 with which such association is made. In some embodiments, station 20 may record failed association attempts and the channels 12 upon which such failures occurred. At intervals during the session (block 404), station 20 may record or calculate data relating to the communication performance exhibited by AP 10 or channel 12 during an associative session. Such data may include for example, average number retries of data transfers required during such session 207, transmit rates 209 and receive rates 205 of such session, etc. Other kinds of data may be recorded or calculated. The recorded data may be correlated with the AP 10 or channel 12 used during such session, and such data may be added to the associative history 29 of the station 20.

By way of example, a process of updating an associative history 29 may in some embodiments calculate and store an AP quality coefficient that mate for example be calculated by algorithm such as the following:

(((0.6*Average Receive Rate)+(0.4*Average Transmit Rate))*Average % retries). Other algorithms, other weights and other parameters may be used.

In some embodiments, a station 20 may store in for example a histogram, two or more values for a channel 12 or an AP 10 for each time of day. A first value may for example, express AP 10 quality as may in some embodiments be calculated in accordance with the AP quality coefficient algorithm above. AP 10 quality may in some embodiments be updated when a station 20 ends an associative session with an AP 10. A second value may be a number of associations between a station 20 and an AP 10 at a particular hour. Such value may also be updated in a histogram. Other values and other number of values may be stored in respect of particular channels 12 or APs 10.

A process for updating an associative history 29 may, for example, be expressed as follows:

Upon association of a station 20 with an AP:

Function connect ( )

{

a=GetSystemTime( );
b=FindHistrogramEntry(a);
BSS[id].Time[b].numOfConnections++;

}

Upon disconnection of a station 20 from an AP:

Function Disconnect( )

{

a=GetSystemTime( );
b=FindHistogramEntry(a);
c=CalculateCurrentAssociationLinkQuality( );
BSS[id].Time[b].LinkQuality+=c;

}

Such pseudo code may be expressed in various languages, circuits or firmware structures. Further, other instructions or series of instructions may be used.

When a station 20 undertakes to associate, channels 12 to be scanned may in some embodiments be ordered, for example, in accordance with the following:

Function OrderBSS(HistogramEntry)

{

for each BSS

{

Coefficient = (0.6 *(BSS.Time[b].LinkQuality/54))+

(0.4*BSS.Time[b].numOfConnections)

Order BSS in ascending order according to calculated

Coefficient.
}

Extract form ordered BSS's channel order.
}

Such pseudo code may be expressed in various languages, circuits or firmware structures. Further, other instructions, series of instructions or algorithms may be used.

It will be appreciated by persons skilled in the art that embodiments of the invention are not limited by what has been particularly shown and described hereinabove. Rather the scope of at least one embodiment of the invention is defined by the claims below.

We claim:

1. A method comprising ordering channels to be scanned by a station based on an associative history of said station.

2. A method as in claim 1, wherein said ordering comprises:
ordering said channels to be scanned at a time of day of an association attempt based on the frequency of past associations by said station with an access point at said time of day of said association attempt.

3. A method as in claim 1, wherein said ordering comprises:
ordering said channels to be scanned based on the number of past successful associations by such station with an access point.

4. A method as in claim 1, wherein said ordering comprises:
ordering said channels to be scanned based on the frequency of past successful associations by such station with an access point.

5. A method as in claim 1, wherein said ordering comprises:
ordering said channels to be scanned based on the transmission quality in past associations by such station with an access point.

6. A method as in claim 5, wherein said ordering based on transmission quality comprises:
evaluating past data transmission rates of said access point.

7. A method as in claim 5, wherein said ordering based on transmission quality comprises:
evaluating past receiving rates of said access point.

8. A method as in claim 1, further comprising:
determining if said station is in a region where channels upon which said access point broadcasts include channels other than channels with which said station has an associative history.

9. A method as in claim 1, further comprising:
determining if a user profile of said station directs an order for scanning channels.

10. A method as in claim 1, wherein said ordering comprises:
determining a final order of channels to be scanned based on at least two orders of channels to be scanned.

11. A method as in claim 10, wherein said determining comprises weighting the importance of at least two orders of channels to be scanned.

12. A device comprising a controller to scan channels in an order determined by an associative history of a station.

13. A device as in claim 12, comprising a storage unit to store said associative history of said station.

14. A device as in claim 12, wherein said associative history includes at least a record of the time of day of prior associations by said station with at least one peer.

15. A device as in claim 12, wherein said associative history includes at least a record of association success rates by said station with at least one peer.

16. A device as in claim 12, wherein said associative history includes a record of the quality of a prior associations with at least one peer.

17. A device as in claim 16, wherein said quality of a prior association comprises transmission rates of said at least one peer.

18. A device as in claim 16, wherein said quality of a prior association comprises receiving rates of said at least one peer.

19. A device as in claim 12, wherein said controller to determine if said station is in a region wherein channels upon which said station may associate include channels other than channels with which said station has an associative history.

20. A device as in claim 12, wherein said controller to determine whether a user profile dictates an order of channels to be scanned by said station.

21. A device as in claim 12, wherein said associative history comprises data on prior associations between a station and a network.

22. A device as in claim 21, wherein said network is a wireless local area network.

23. An article comprising a storage medium, having stored thereon instructions, that when executed, result in:
arranging channels in a sequence for scanning by a station based on an associative history of said station.

24. An article as in claim 23, wherein said instructions when executed further result in:
arranging said channels in a sequence for scanning by a station based on a user profile.

25. An article as in claim 23, wherein said instructions when executed further result in:
weighting the importance of at least two sequences of channels to be scanned.

26. A device comprising:
a dipole antenna, and
a controller to scan channels in a sequence determined by an associative history of a station.

27. A device as in claim 26, comprising a memory to record an associative history of said station.

28. A device as in claim 26, wherein said memory to store a user profile.
